(19) United States
(12) Patent Application Publication
(10) Pub. No.: US 2013/0250379 A1
(43) Pub. Date: Sep. 26, 2013

(54) SYSTEM AND METHOD FOR SCANNING PRINTED MATERIAL

(71) Applicants: Luca RIGAZIO, San Jose, CA (US); Woosuk CHANG, Cupertino, CA (US); Andrea MELLE, Santa Clara, CA (US)

(72) Inventors: Luca RIGAZIO, San Jose, CA (US); Woosuk CHANG, Cupertino, CA (US); Andrea MELLE, Santa Clara, CA (US)

(73) Assignee: PANASONIC CORPORATION, Osaka (JP)

(21) Appl. No.: 13/424,587

(22) Filed: Mar. 20, 2012

(51) Int. Cl. H04N 1/56; H04N 1/40

(52) U.S. Cl. 358/538; 358/448

(57) ABSTRACT

System and method of continuously scanning turned pages of printed material, the method including capturing a first image of a first page of the printed material in a front of an imaging device, detecting a page turn, the detecting including setting a motion threshold value of the captured first image, the motion threshold value, scanning and obtaining motion values for successive image frames of the printed material, and comparing the motion value of each successive image frame with the motion value of a preceding image frame. The method further includes capturing a second image of a next page, determining whether the first image and the second image is of the same page, the determining including performing first and second threshold tests, wherein the second threshold test is performed faster and is less accurate than the first threshold test.

### BACKGROUND

1. Field of the Disclosure

The present disclosure relates to the field of scanning printed material and more particularly relates to continuously scanning the pages of a book.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

2. Background Information

Some known book scanning systems require a user to press a button or require some type of user input to indicate when a page has been turned and when to begin scanning a new page. Other book scanning systems have attempted to detect natural page turns without external input from the user (i.e., by detecting the movement of a hand turning a page); however, such systems are prone to error, either by determining that a page has been turned when it has not, or by failing to detect a turned page, thereby slowing down the book scanning process. There has thus arisen a need for a system and method for creating a scanned book file that can reliably detect the natural action of page turning, while detecting only real page turns.

### SUMMARY OF THE DISCLOSURE

A non-limiting feature of the disclosure efficiently provides a simple, stable, and fast system for the creation of a digital representation of a book or a selected section of a book by allowing nonstop continuous scanning of the pages of the book. According to another feature, the disclosure provides for the natural action of page turning, while detecting only real page turns, and further allows for natural finger interaction to select book text for input.

According to a further non-limiting feature, the book scanning system and method allows everyday, unsophisticated users to simply and easily scan books. The book scanning occurs at a speed appropriate to natural human interaction. The system has a very low error rate, making the continuous scanning of books very easy and useful for users. Pages are scanned, new pages are detected, compared with previous pages to prevent duplications, image quality is improved, and a full book is compiled based on the scanned images. The system can also detect the user selections of specific book areas to scan based on gesture recognition.

According to another non-limiting feature, the system and method uses efficient page turn recognition and gesture region detection with same page detection in a continuous book scanning mode, the page turn detection feature speeds up and improves accuracy so as to prevent the user being slowed down.

According to yet another non-limiting feature, the user can naturally interact with a book during the scanning process, (similar to reading a book). As such, the book can face up/toward the user, so user can see what he/she is scanning. Also, the system and method are faster than related art copy machines in which the user lifts the cover of the copier and turns the upside-down facing book pages each time a scan is desired.

According to still another non-limiting feature, the page turn recognition system does not require the user to press any buttons or otherwise provide any input aside from merely turning the book pages, which speeds up the book scanning process. In other words, the mere turning of a page provides the instruction to the system to begin scanning the next page of the book.

According to a further non-limiting feature, the present system is economical does not require the use of a dedicated or specialized camera or scanner, rather an off-the-shelf webcam or other imaging device may be used. According to still a further non-limiting feature, only a single such imaging device can be used, although those skilled in the art would appreciate that multiple imaging devices may be used in alternative embodiments.

A method according to a non-limiting feature of the disclosure provides a method of continuously scanning turned pages of printed material, the method including capturing, using an imaging device, a first image of a first page of the printed material in a field of view of the imaging device, detecting by a computer processor, a page turn of the page of the printed material, the detecting including setting a motion threshold value of the captured first image, the motion threshold value having a threshold distance value and threshold a direction value, scanning and obtaining motion values for successive image frames of the printed material, each obtained motion value having a distance value and a direction value, comparing the motion value of each successive image frame with the motion value of a preceding image frame, such that if the motion value of a successive image frame exceeds the motion threshold value, a page turn is determined. The method further includes capturing, using the imaging device, a next, second image of a next page of the printed material in the field of view of the imaging device, and determining whether the first image and the second image is of the same page, the determining including performing a first threshold test in which first features of the first image and second image are compared, and performing a second threshold test in which second features, different from the first features, of the first and second image are compared, wherein the second threshold test is performed faster and is less accurate than the first threshold test The method additionally includes storing the second image in a computer memory if the both first threshold test and second threshold test determine that the second image is not of the same page as the first image.

In a feature, the determining whether the first image and the second image is of the same page further includes performing a third threshold test in which third features, different from the first features, of the first image and second image are compared, wherein the third threshold test is performed more slowly and is more accurate than the first and second threshold tests.

According to another feature, the performing the third threshold test is performed only when the performing of the first threshold test and the performing of the second threshold test both determine that the first image and the second image is not of the same page.

In a further feature, the performing the third threshold test includes detecting a first plurality of unique features of the first image, detecting a second plurality of unique features of the second image, matching at least one first unique feature of the first plurality of unique features with at least one second unique feature of the second plurality of unique features, creating a trajectory between the at least one first unique feature and the at least one second unique feature, comparing the created trajectory with a predetermined threshold trajectory, and outputting a determination as to whether or not the first image and the second image are of the same image depending on the result of the comparing.

Another feature may further include deleting the lower quality of the first image and the second image when the determining determines that the first image and the second image is of the same page. Also, the performing the second threshold test may include performing run length smearing of the contents of the first image, performing run length smearing of the contents of the second image, determining a vector of the run length smeared contents of the first image, determining a vector of the run length smeared contents of the second image, comparing the determined vector of the first image with the determined vector of the second image, and outputting a determination as to whether or not the first image and the second image are of the same image depending on the result of the comparing. Additionally, the contents of the first image and the contents of the second image may be text data.

According to a further feature, detecting a hand gesture is provided, the detecting of a hand gesture including, storing a skin value, detecting a moving object in the field of view of the imaging device, obtaining an exterior characteristic value of the detected object, comparing the obtained exterior characteristic value of the moving object with the stored skin value, determining whether the moving object is a hand depending on the result of the comparing of the obtained exterior characteristic value, tracking the motion of the moving object in the field of view when the determining whether the moving object is a hand determines that the moving object is a hand.

Also provided may be the selecting of a portion of the second image, the selecting including determining at least a first position and a second position of the hand in the field of view, the first position and second positions specifying an area of the next page to be stored, and storing only the area of the next page to be stored.

According to an additional feature, the method may further include obtaining a background page color value of the next page, determining when the moving object stops moving, replacing moving object image data with a background page color corresponding to the background page color value, and storing the second image of the next page.

Also, another feature may include determining the page numbers of the first page and next page of the printed material, comparing the page numbers of the first page and next page, and providing a cue to a user when the first page and next page are out of sequence.

An additional feature provides a method of continuously scanning turned pages of printed material, the method including capturing, using an imaging device, a first image of a first page of the printed material in a field of view of the imaging device, capturing, using the imaging device, a next, second image of a next page of the printed material in the field of view of the imaging device, determining whether the first image and the second image is of the same page, the determining including performing a first threshold test in which first features of the first image and second image are compared, and performing a second threshold test in which second features, different from the first features, of the first and second image are compared, wherein the second threshold test is performed faster and is less accurate than the first threshold test, and storing the second image in a computer memory if the both first threshold test and second threshold test determine that the second image is not of the same page as the first image.

According to yet another feature, the determining whether the first image and the second image is of the same page further includes performing a third threshold test in which third features, different from the first features, of the first image and second image are compared, wherein the third threshold test is performed more slowly and is more accurate than the first and second threshold tests. Also, the performing the third threshold test may be performed only when the performing the first threshold test and the performing the second threshold test both determine that the first image and the second image is not of the same page.

In still another feature, the performing the third threshold test may include detecting a first plurality of unique features of the first image, detecting a second plurality of unique features of the second image, matching at least one first unique feature of the first plurality of unique features with at least one second unique feature of the second plurality of unique features, creating a trajectory between the at least one first unique feature and the at least one second unique feature, comparing the created trajectory with a predetermined threshold trajectory, and outputting a determination as to whether or not the first image and the second image are of the same image depending on the result of the comparing. An additional feature may further include deleting the lower quality of the first image and the second image when the determining determines that the first image and the second image is of the same page.

Further, the performing of the second threshold test may include performing run length smearing of the contents of the first image, performing run length smearing of the contents of the second image, determining a vector of the run length smeared contents of the first image, determining a vector of the run length smeared contents of the second image, comparing the determined vector of the first image with the determined vector of the second image, and outputting a determination as to whether or not the first image and the second image are of the same image depending on the result of the comparing. The method may also further include determining the page numbers of the first page and next page of the printed material, comparing the page numbers of the first page and next page, and providing a cue to a user when the first page and next page are out of sequence.

The method according to claim 12, further including at least one of an audible or visual cue to a user when the determining determines that the first image and the second image is of the same page.

Also provided may be a method of continuously scanning turned pages of printed material, the method including capturing, using an imaging device, an image of a page of the printed material in a field of view of the imaging device, and detecting by a computer processor, a page turn of the page of the printed material, the detecting including setting a motion threshold value of the captured first image, the motion threshold value having a threshold distance value and a threshold direction value, scanning and obtaining motion values for successive image frames of the printed material, each obtained motion value having a distance value and a direction value, and comparing the motion value of each successive image frame with the motion value of a preceding image frame, such that if the motion value of a successive image frame exceeds the motion threshold value, a page turn is determined.

The method may further include detecting a hand gesture, the detecting a hand gesture including storing a skin value, detecting a moving object in the field of view of the imaging device, obtaining an exterior characteristic value of the detected object, comparing the obtained exterior characteristic value of the moving object with the stored skin value, determining whether the moving object is a hand depending on the result of the comparing the obtained exterior characteristic value, and tracking the motion of the moving object in the field of view when the determining whether the moving object is a hand determines that the moving object is a hand.

The method may further include selecting a portion of the second image, the selecting including determining at least a first position and a second position of the hand in the field of view, the first position and second positions specifying an area of the next page to be stored, and storing only the area of the next page to be stored.

According to an additional feature, the method may further include obtaining a background page color value of the next page, determining when the moving object stops moving, replacing moving object image data with a background page color corresponding to the background page color value, and storing the second image of the next page.

A feature of the present disclosure also provides an image processing system connected to an imaging device and a computer having a memory, the imaging device configured to capture first and second images of respective first and second pages of printed material in a field of view of the imaging device, the image processing system including a determiner configured to determine whether the first image and the second image is of the same page by executing a first threshold test in which first features of the first image and second image are compared, and executing a second threshold test in which second features, different from the first features, of the first and second image are compared, wherein the second threshold test is performed faster and is less accurate than the first threshold test, and a storage processor configured to instruct the computer to store the second image in the computer memory if the both first threshold test and second threshold test determine that the second image is not of the same page as the first image.

Another feature of the present disclosure provides a page turn detection system connected to an imaging device and a computer having a memory, the imaging device configured to capture an image of printed material in a field of view of the imaging device, the image processing system including, a motion threshold value setter configured to set a motion threshold value of the captured first image, the motion threshold value having a threshold distance value and a threshold direction value, a scanning processor configured to instruct at least one of the imaging device and the computer to scan and obtain motion values for successive image frames of the printed material, each obtained motion value having a distance value and a direction value, and a comparator configured to compare the motion value of each successive image frame with the motion value of a preceding image frame, such that if the motion value of a successive image frame exceeds the motion threshold value, a page turn is detected.

In accordance with a further feature of the disclosure, provided is an apparatus for continuously scanning turned pages of printed material, the apparatus including a camera configured to capture first and second images of respective first and second pages of printed material in a field of view of the imaging device, a determiner configured to determine whether the first image and the second image is of the same page by executing a first threshold test in which first features of the first image and second image are compared, and executing a second threshold test in which second features, different from the first features, of the first and second image are compared, wherein the second threshold test is performed faster and is less accurate than the first threshold test, and a memory configured to store the second image if the both first threshold test and second threshold test determine that the second image is not of the same page as the first image.

In accordance with yet another feature, provided is a page turn detector including a camera configured to capture an image of printed material, a motion threshold value setter configured to set a motion threshold value of the captured first image, the motion threshold value having a threshold distance value and a threshold direction value, a scanner configured to scan and obtain motion values for successive image frames of the printed material, each obtained motion value having a distance value and a direction value, and a comparator configured to compare the motion value of each successive image frame with the motion value of a preceding image frame, such that if the motion value of a successive image frame exceeds the motion threshold value, a page turn is detected.

Another feature provides at least one non-transitory computer-readable medium readable by a computer for continuously scanning turned pages of printed material, the at least one non-transitory computer-readable medium including a first capturing code segment that, when executed, captures, using an imaging device, a first image of a first page of the printed material in a field of view of the imaging device, a second ccapturing code segment that, when executed, captures, using the imaging device, a next, second image of a next page of the printed material in the field of view of the imaging device, a determining code segment that, when executed: performs a first threshold test in which first features of the first image and second image are compared, and performs a second threshold test in which second features, different from the first features, of the first and second image are compared, wherein the second threshold test is performed faster and is less accurate than the first threshold test, and a storing code segment that, when executed, stores the second image in a computer memory if the both first threshold test and second threshold test determine that the second image is not of the same page as the first image.

A further feature provides at least one non-transitory computer-readable medium readable by a computer for detecting a page turn of a page of printed material, the at least one non-transitory computer-readable medium including a capturing code segment that, when executed, captures an image of a page of the printed material, a setting code segment that, when executed, sets a motion threshold value of the captured first image, the motion threshold value having a threshold distance value and a threshold direction value, a scanning code segment that, when executed, scans and obtains motion values for successive image frames of the printed material, each obtained motion value having a distance value and a direction value, and a comparing code segment that, when executed, compares the motion value of each successive image frame with the motion value of a preceding image frame, such that if the motion value of a successive image frame exceeds the motion threshold value, a page turn is detected.

Other exemplary embodiments and advantages of the present invention may be ascertained by reviewing the present disclosure and the accompanying drawings, and the above description should not be considered to limit the scope of the present invention.

### BRIEF DESCRIPTION OF THE DRAWINGS

The present invention is further described in the detailed description which follows, in reference to the noted plurality of drawings, by way of non-limiting examples of preferred embodiments of the present invention, in which like characters represent like elements throughout the several views of the drawings, and wherein:

FIG. 1 is an illustrative embodiment of a general purpose computer system, according to an aspect of the present disclosure;

FIG. 2 is a schematic diagram illustrating schematic configurations of a book scanner and a computer system;

FIG. 3 is an overview flowchart explaining the general operation of the disclosure;

FIG. 4 is a flowchart explaining in greater detail the page turn detection process of the disclosure;

FIG. 5 is a flowchart explaining in greater detail the hand detection process of the disclosure;

FIG. 6 is a schematic diagram illustrating the process of obtaining a cutout area from a specified area of the disclosure;

FIG. 7 is a flowchart explaining in greater detail the same page detection process of the disclosure;

FIG. 8A is a flowchart explaining in greater detail the run length processing step of the disclosure;

FIG. 8B is a data example corresponding to the flowchart of FIG. 8A;

FIG. 9A is a flowchart explaining in greater detail the pixel map correlation step of the disclosure;

FIG. 9B is a data example corresponding to the flowchart of FIG. 9A;

FIG. 9C is another data example corresponding to the flowchart of FIG. 9A; and

FIG. 10 is a flowchart explaining in greater detail the image storage process of the disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

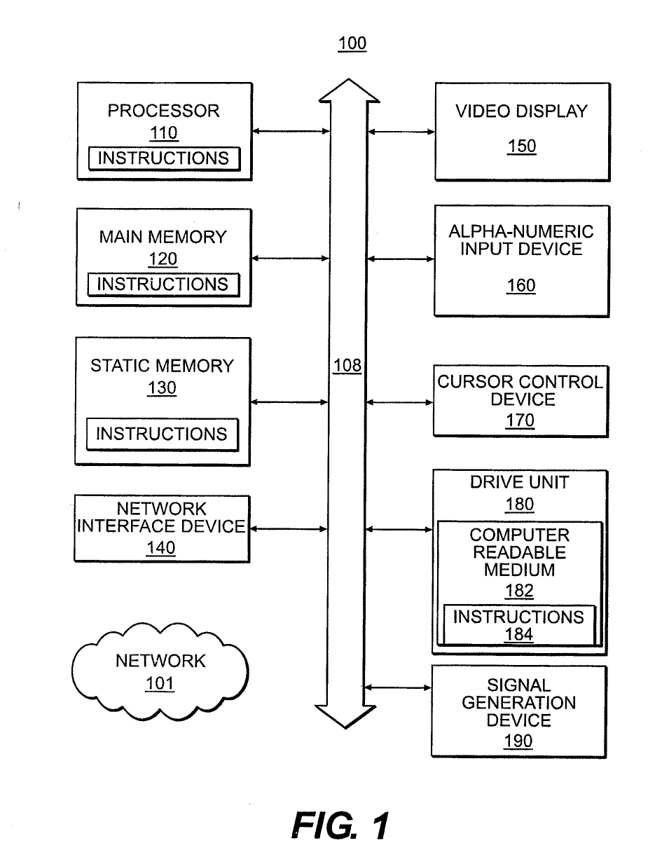

Referring to the drawings wherein like characters represent like elements, FIG. 1 is an illustrative embodiment of a general purpose computer system, on which a system and method for scanning printed material can be implemented, which is shown and is designated 100. The computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices.

In a networked deployment, the computer system may operate in the capacity of a server or as a client user computer in a server-client user network environment, or as a peer computer system in a peer-to-peer (or distributed) network environment, including but not limited to femtocells or microcells. The computer system 100 can also be implemented as or incorporated into various devices, such as a personal computer (PC), a tablet PC, a set-top box (STB), a personal digital assistant (PDA), a smartphone, a mobile device, a global positioning satellite (GPS) device, a palmtop computer, a laptop computer, a desktop computer, a communications device, a wireless telephone, smartphone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 may include a processor 110, for example, a central processing unit (CPU), a graphics processing unit (GPU), or both. Moreover, the computer system 100 can include a main memory 120 and a static memory 130 that can communicate with each other via a bus 108. As shown, the computer system 100 may further include a video display (video display unit) 150, such as a liquid crystal display (LCD), an organic light emitting diode (OLED), a flat panel display, a solid state display, or a cathode ray tube (CRT). Additionally, the computer system 100 may include an input (input device) 160, such as a keyboard or touchscreen, and a cursor control/pointing controller (cursor control device) 170, such as a mouse, trackball, touchscreen, touchpad or trackpad. The computer system 100 can also include storage, such as a disk drive unit 180, a signal generator (signal generation device) 190, such as a speaker or remote control, and a network interface (e.g., a network interface device) 140.

In a particular embodiment, as depicted in FIG. 1, the disk drive unit 180 may include a computer-readable medium 182 in which one or more sets of instructions 184, e.g. software, can be embedded. A computer-readable medium 182 is a tangible article of manufacture, from which one or more sets of instructions 184 can be read. Further, the instructions 184 may embody one or more of the methods or logic as described herein. In a particular embodiment, the instructions 184 may reside completely, or at least partially, within the main memory 120, the static memory 130, and/or within the processor 110 during execution by the computer system 100. The main memory 104 and the processor 110 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal, so that a device connected to a network 101 can communicate voice, video and/or data over the network 101. Further, the instructions 184 may be transmitted and/or received over the network 101 via the network interface device 140.

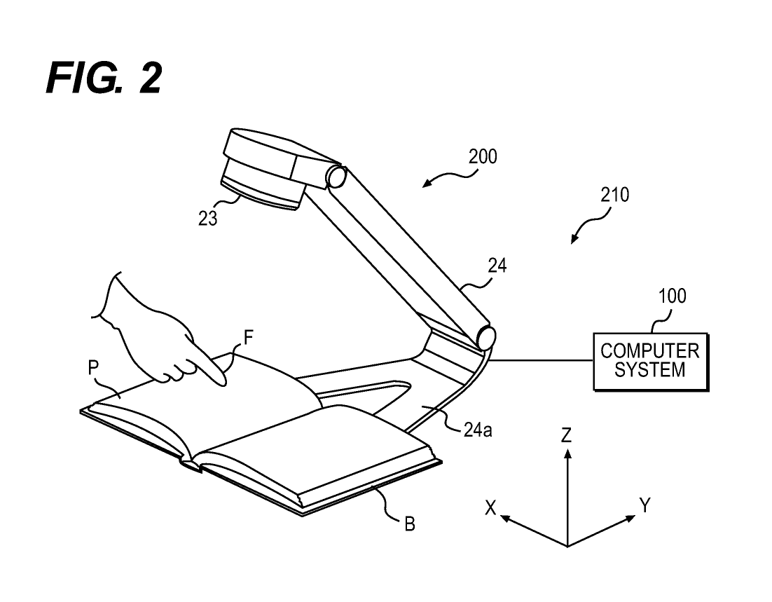

FIG. 2 illustrates a configuration of a document scanning system 210 according to a non-limiting feature of the disclosure. The document scanning system scans an image of a paper surface of a book B (although those skilled in the art would appreciate that any multi-paged or bound document, such as a magazine, leaflet, brochure and the like could be used) and obtains image data (i.e., text, illustrations and the like) of the paper/printed matter surface. The document scanning system 210 includes a book scanner 200 and above-described computer system 100. Although FIG. 2 shows the scanner 200 connected to the computer system 100 via a cable, those skilled in the art would appreciate that such connection can be made wirelessly via, e.g., network 101.

The book scanner 200 may be provided with a camera 23 capturing an image of a paper surface of the book B and a stand 24 holding the camera 23. It is noted that the term “camera” as used herein means any suitable imaging device, including but not limited to a portable digital camera, webcam, dedicated scanner, and the like. The stand 24 is placed on a surface such as a desk, tabletop or flat part of stand 24a. While the stand 24 is shown in the general form of an acute angle, those skilled in the art would appreciate that the stand can take any suitable shape so long as the field of view of the camera 23 can include a book B.

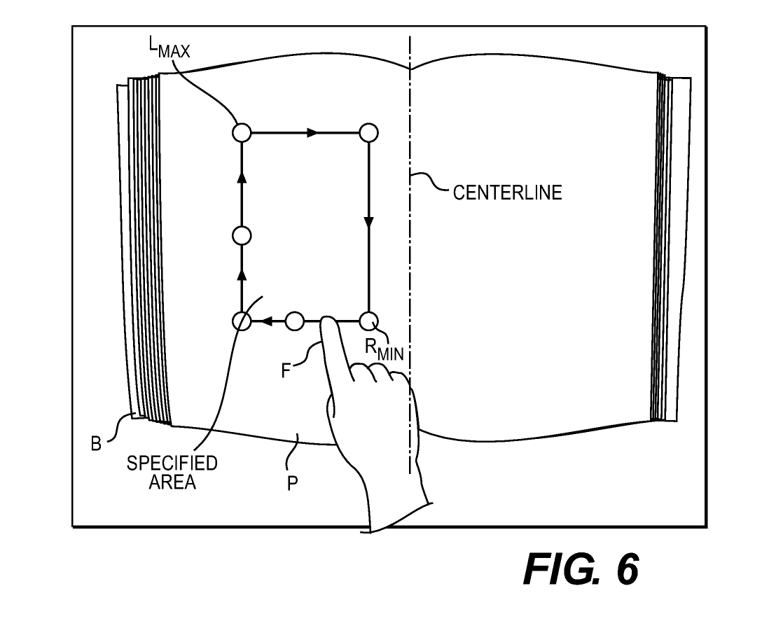

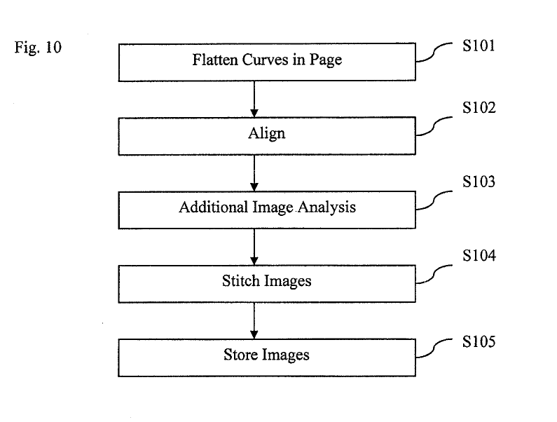

The book B is set on the surface below the camera 23. The camera 23 scans and captures an image of a paper surface of the book B. An image of a paper surface is captured in a state where the book B is naturally opened, and a captured image of a two-page spread of the book B is thus obtained. Since books and other bound volumes typically do not open in a completely planar manner (i.e., the innermost portions of the pages are bent toward the spine of the book along the centerline, shown in FIG. 6), planarization (flattening of the curves) is performed on an image of a distorted paper surface in order to obtain a uniform planarized image of the two-page surface spread, as described below with reference step S101 to FIG. 10.

As used herein, the term “capture” as applied to an image refers to the pickup of the image by an imaging element (such as a CCD or CMOS sensor) and storage of the image in volatile memory 120, 130, such as RAM (e.g., such that the user can view a live image of the book displayed on video display 150 without storing the image to non-volatile memory; and the term “storage” refers to the storage of the image in non-volatile memory 182, such as read-only memory (ROM), flash memory, ferroelectric RAM (F-RAM), EVMs (Electronic voting machines), magnetic computer storage devices and the like. It is noted that the system 210 can not only scan a book in continuous mode, but can also be configured to be switched by a user between a continuous scanning mode and individual page scanning mode. Also as used in the specification and claims, the term “page” can refer to either a single page or to the above-described two-page spread of an open book B.

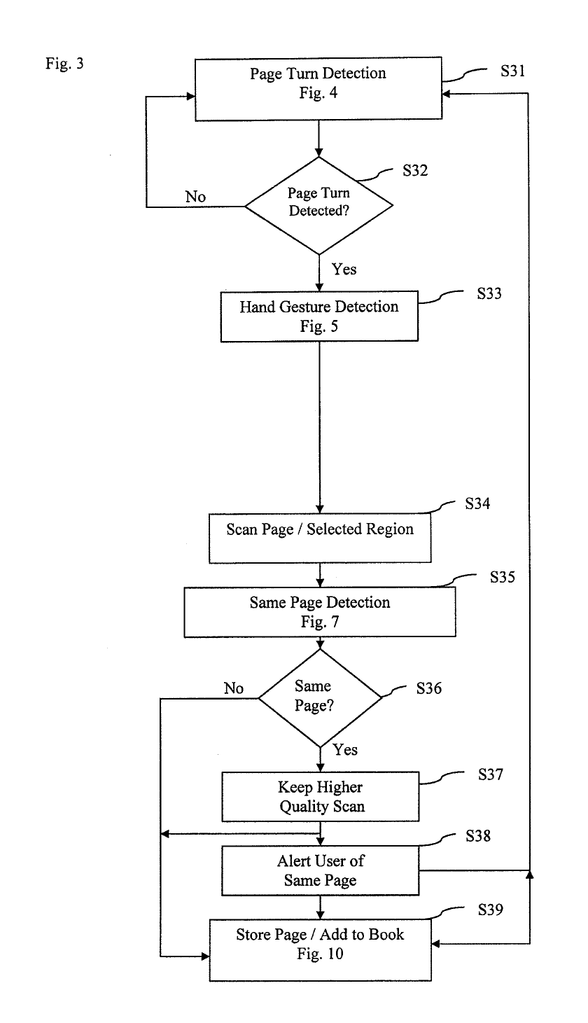

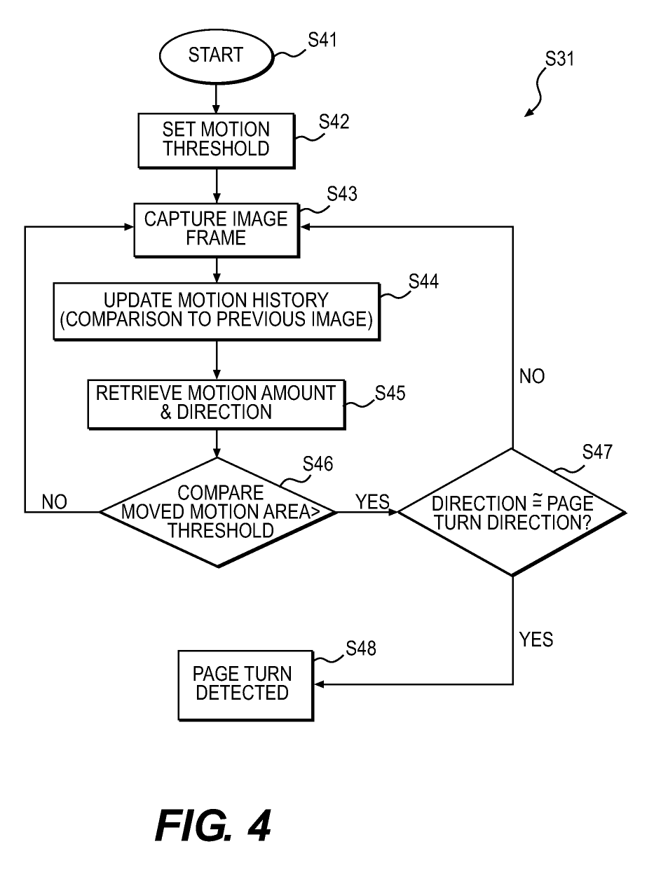

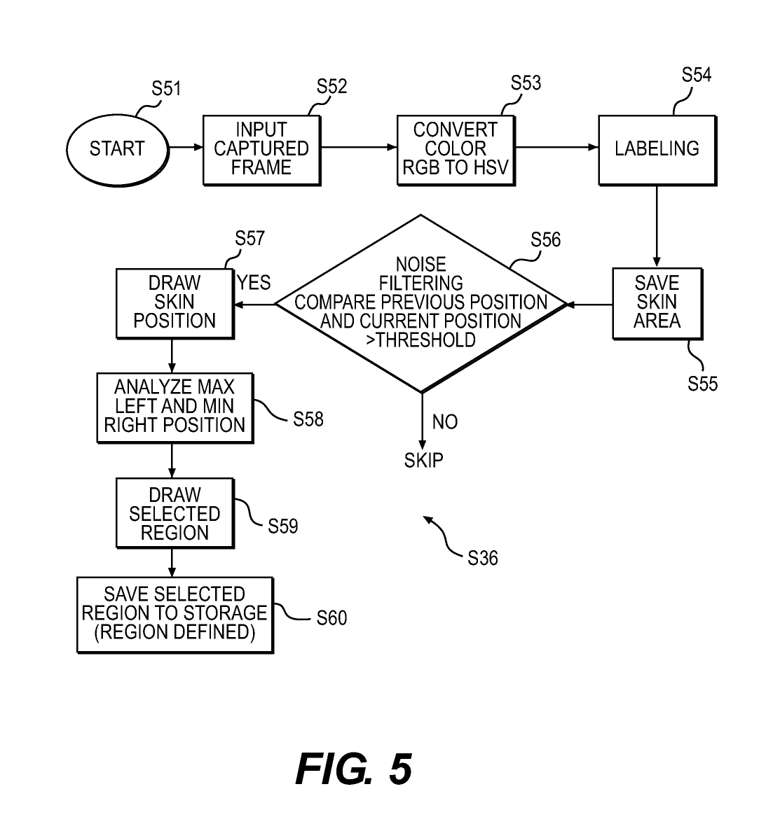

FIG. 3 shows an overview flowchart explaining the general operation of a non-limiting aspect of the disclosure. At step S31 (the details of which are further explained below in relation to FIG. 4) a page turn process is performed. If, at step S32, a page turn is not detected, the process returns to step S31. If, at step S32 a page turn is detected, the process proceeds to an optional hand gesture detection process at step S33, the details of which are further explained below in relation to FIG. 5. The hand gesture detection process is performed when the user desires to scan and store only a portion (i.e., a cutout image) of a page P, rather than an entire page or page spread. The hand detection process, as further explained below, allows the user to obtain a cutout image of a page by directly specifying an area on a page surface with a pointer F (such as a hand or finger) placed in the field of view of the camera (i.e., the pointer is placed between the camera and the page surface). In the event that the hand gesture process is employed, once the selected region is specified, it is scanned as a cutout portion. In the event that the hand gesture detection process is not employed, the processing proceeds to step S34 to scan the page.

According to a non-limiting feature, the scanned page, spread or cutout portion is stored in non-volatile memory 120 or 130 in order to save memory space of the non-volatile storage device 182; however, those skilled in the art would appreciate that the scanned page or cutout portion may alternatively be non-volatile memory 182.

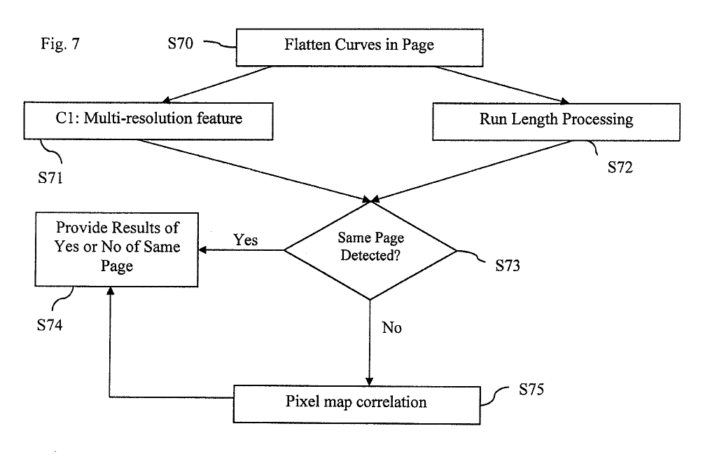

Once the page or cutout portion is scanned, the process of determining whether the scanned page or cutout portion (collectively referred to as the scanned image) is the same as the previously scanned image on a preceding page (or page spread) is performed at step S35, the details of which are further explained below in relation to FIG. 7. Note that this process is not performed for the first scanned image. Also, for purposes of reference, the previously scanned image may also be referred to herein as the first scanned image, and the following scanned image may also be referred to herein as the next image, just-scanned image or second image. If the processing determines at step S36 that the next image is the same image as the previous image, then the processing optionally proceeds to step S37, where the previous and next images are compared. The higher quality image is saved and stored and saved to the scanned book file at step S39 (the details of which are further explained below in relation to FIG. 10), and at step S38 a visual and/or audible cue is relayed to the user that they failed to properly turn the page in the book (i.e., that the just-scanned page (or page spread) is the same as the previously-scanned page (or page spread)). If the optional step of keeping the higher quality scan is omitted, then the processing proceeds directly from step S36 to step S38, and the processing returns to the page turn detection S31. If at step S36 the processing determines that the next image is not the same image as the previous image, then the processing proceeds to step S39, where the scanned image is saved and stored and saved to the scanned book file (the details of which are further explained below in relation to FIG. 10), and the processing returns to the page turn detection S31. It is noted that alternatively or in addition to comparing the just-scanned image with the previously-scanned image, the present disclosure may compare the just-scanned image to any or all of the previously scanned images.

In accordance with an optional feature, the present disclosure provides for the detection of page numbers, either through user finger pointing and detection or through software 184 and/or 130. Once the page numbers of each image are detected, the page numbers of each image are be compared. In this way, not only can the computer system 100 to determine whether the scanned image is the same as the previously scanned image on a preceding page (or page spread), but the system can also determine whether the user has turned too many pages in the book (by detecting a skip in the numerical sequence of page numbers). Once such an anomaly has been detected, a cue may be provided to the user.

FIG. 4 is a more detailed flowchart explaining the page turn detection process S32. At step S41 the program initiates, either passively or when a user actively initiates the program by, e.g., pushing a button, clicking on an icon, actuating with voice, and the like to initiate, e.g., the continuous scanning mode. At step S42 the motion threshold value is loaded and set either by the manufacturer or by the user. The user can change the motion threshold value in a configuration mode, in situations where the user desires greater or less of such a value, e.g., if the user is elderly or has arthritis. The motion threshold value has two components, namely, a distance value and a direction (or vector) value. The vector value component assists the computer system 100 in differentiating whether a page is being turned or whether the book is merely being adjusted, in that these two actions have different directions of movement. It is also noted that the motion to be detected can be either motion of a hand or a book page. For example, if the vector threshold value is set to a right-to-left direction (the typical direction of movement of a hand or page when turning pages in an English-language book), then an up-down or left-to-right motion will not meet the vector threshold value. It is appreciated by those skilled in the art that diagonal motions, or motions oblique to the right-to-left motions, may be included in the threshold value component (to, e.g., account for unconventional page turns).

At step S43 an image in the field of view of the camera 23 (such as the book B) is captured as an image frame by the camera 23 and the motion value of each frame is obtained, the obtained motion value having a distance value and a direction value. At step S44 the motion history of each captured image frame is cycled and monitored, wherein the last-captured frame is compared the previously-captured frame to check for the motion amount and direction within the field of view of the camera. At step S45, the motion value (including the motion amount value and direction value) of the frame is obtained, and in step S46 the distance value (which may include the motion amount and area) is compared with the threshold distance value. Basically, in step S46 quantifies in one number the amount of motion in a scene (sum of module of motion vectors). If this one number is greater than a fixed numeric threshold, then the amount of motion in the current frame is considered sufficient to proceed further and consider direction of motion. Otherwise, the frame is considered static, and it is determined that user is not acting in the scene with hands. If the distance value is greater than the threshold distance value, then the processing proceeds to step S47. If the distance value is not greater than the threshold distance value, then the processing returns to step S43. At step S47, the direction value of the captured frame is compared with the threshold direction value, and if the direction value is equal to the threshold direction value (or range of values), then a page turn is detected and determined at step S48. If at step S47, the direction value is not equal to the threshold direction value, then the processing returns to step S43. It is further noted that the motion threshold value can be self-calibrating when the motion history is captured.

FIG. 5 is a more detailed flowchart explaining the hand detection process S33, wherein a only selected portion of the book page (or page spread) may be scanned (in the event the user does not want to scan an entire book page). At step S51 the program is initiated, and at step S52 an image in the field of view of the camera 23 is captured as an image frame. At step S53 the captured image is converted from RGB (Red, Green, Blue) color representation to HSV (Hue, Saturation, Value) color representation. At step S54 connected component labeling is performed, wherein an image is scanned pixel-by-pixel, from top to bottom and left to right in the frame, in order to identify connected pixel regions (in the form of, e.g., a hand). At step S55 the labeled image data in the form of skin area is stored and analyzed to obtain a skin tone value (or range of skin tone values). In this way, a wide variety skin tones may be analyzed, and it is noted that the system 210 can also account for gloves and other non-skin tones.

At step S56 noise filtering is performed, wherein the skin area is checked for noise and noise in the skin area is filtered by a known noise-filtering program. Also in step S56 the position of the skin area in the last-captured frame is compared with position of the skin area in the previously-captured frame to determine whether the skin area has moved beyond a threshold amount. If the user's hand is not deemed to have moved beyond the threshold amount, then the process terminates, and if the user's hand is deemed to have moved beyond the threshold amount, then it is determined that the user is in the process of selecting a cutout image for storing, and the processing moves to step S57.

At step S57 the skin position is drawn, namely, the skin area is displayed on the video display 150 in real time. Thereafter, at step S58 the computer system 100 analyzes the maximum left position and minimum right position in order to create a selected region (specified area) as the cutout portion. FIG. 6 shows a schematic view of the process of obtaining a cutout area from a specified area. For example, the maximum left position Lmax and the minimum right position Rmin are shown in FIG. 6, and the area between these two points is designated as the specified area. At step S59 the analyzed region is displayed on the video display 150 as the specified area to be confirmed by the user as the cutout portion to be saved. At step S60 the user confirms the specified area as the cutout portion to be saved. Such confirmation may be active, e.g., by pushing a button, clicking on an icon, actuating with voice, or may be passive, e.g., by holding the hand still for a predetermined amount of time to signify to the computer system 100 that the user accepts the specified area as the cutout area, for example using a process described in Japanese Patent Application No. 2011-159873, the contents of which are expressly incorporated by reference in its entirety. If the user does not accept the specified area as the cutout area, such non-acceptance may be active (described above) or passive, e.g. by waving the hand back and forth, or other gesture, and the process returns to step S58. Once the user accepts the specified area to be saved as the cutout area, the cutout area is stored in memory 182 and the volatile memory 120, 130 containing the specified area is cleared in order to create storage space for the next page scan. It is noted that alternatively or additionally, the cutout area may be obtained by using two hands, for example by using two hands to create a “box” around the specified area by contacting the index fingers to respective thumbs on opposite hands, or may be obtained in a manner disclosed in U.S. patent application Ser. No. 13/370,799, the contents of which are expressly incorporated by reference in its entirety.

It is also noted that the hand detection process may be configured to detect a still (unmoving) hand, in a situation where, e.g., a user desires to cover up a page blemish with a hand. In such a case, the detected skin area is replaced with either a white color, another color corresponding to a background page color of the book B, or any other specified color.

FIG. 7 is a more detailed flowchart explaining the same page detection process S35, wherein it is determined whether a currently-scanned book page (or page spread) is the same as a previously-scanned book page (or page spread). At step S70 a process to flatten the curves in the book page (planarization) is performed on an image of a distorted paper surface (as shown e.g., in FIG. 6) in order to obtain a uniform planarized image of the two-page surface spread, in a manner known in the art, for example using a process described in U.S. patent application Ser. No. 13/417,668, the contents of which are expressly incorporated by reference in its entirety.

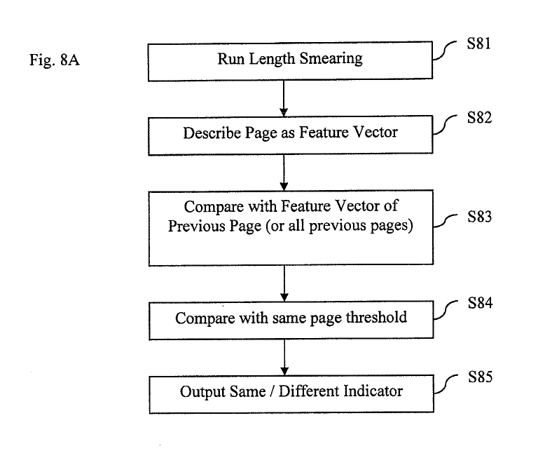

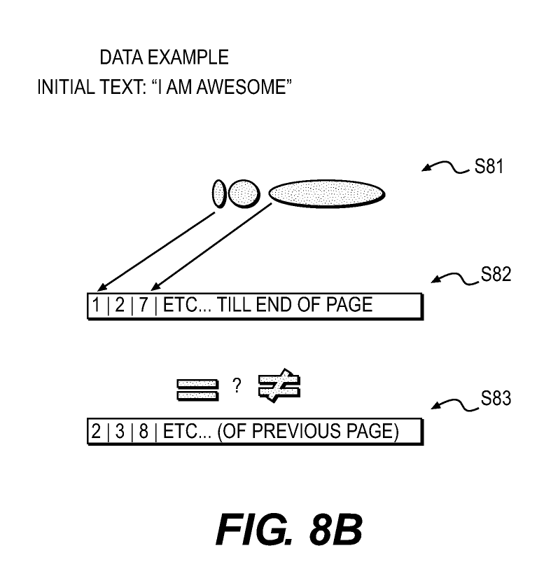

At step S71, a multiresolution process is performed, wherein the data of a previously-scanned image (or images) and the data of a just-scanned image are subdivided and compared until a conclusion is reached as to whether the previously-scanned image and the just-scanned image are the same image. At step S72 a run length processing step is performed on the data of the previously-scanned image (or images) and the data of the just-scanned image, which is described in further detail in FIG. 8A (data structure). It is noted that either of step S71 and step S72 may be performed before the other, or step S71 and step S72 may be performed at the same time (i.e., in parallel, as shown in FIG. 7). It is noted that step S72, while faster than step S71, is not as accurate at making a same page determination, and in a non-limiting aspect, step S72 is performed before step S71.

If, at step S73, both steps S71 and S72 determine that the previously-scanned image and the just-scanned image are the same image (i.e., that the just-scanned page (or page spread) is the same page as the previously-scanned page (or page spread), in other words, the user did not turn the page after scanning), then the processing proceeds to step S74, where the results of the same page determination is provided to the system 100. Thereafter, the processing proceeds to step S38 (described with respect to FIG. 3), whereupon the user is alerted that the just-scanned page is the same page as the previously-scanned page.

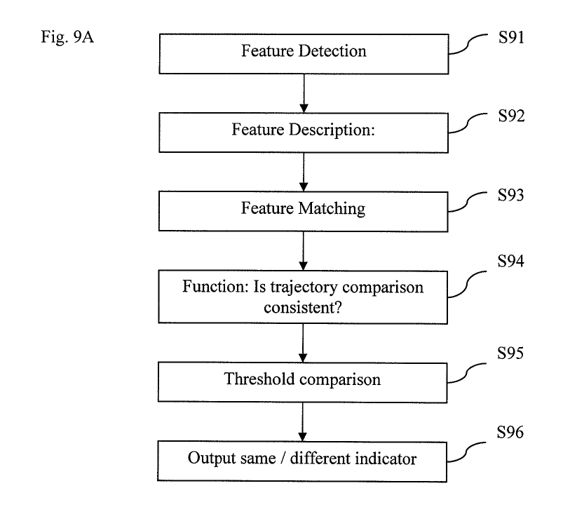

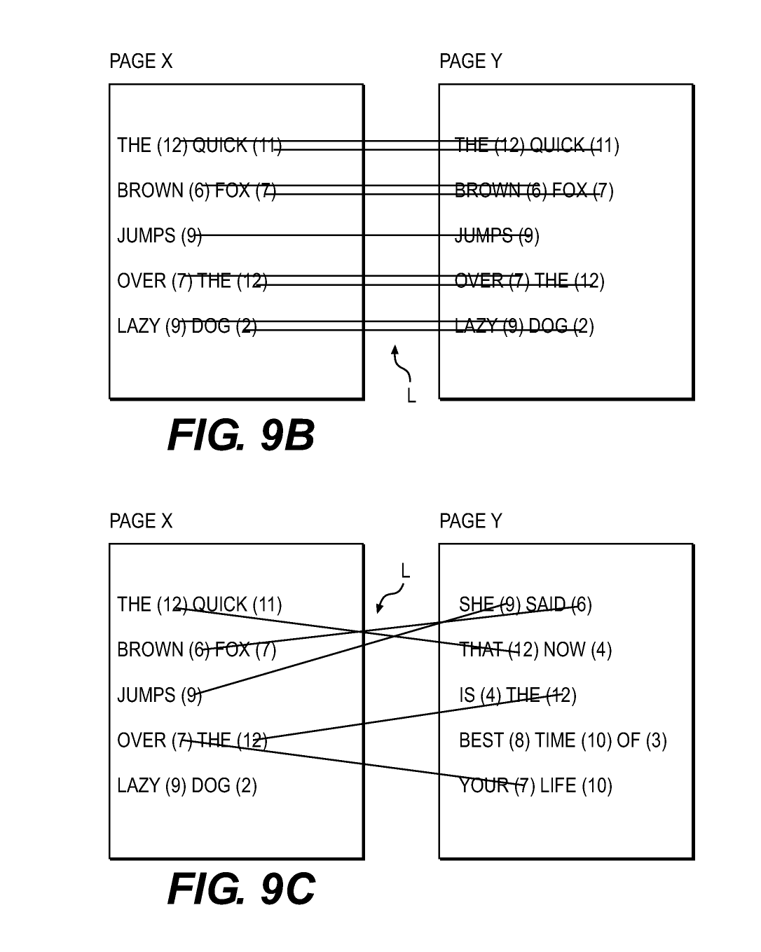

If at step S73 the steps S71 and S72 do not agree that the previously-scanned image and the just-scanned image are the same image, or alternatively if step S71 determines that the previously-scanned image and the just-scanned image are not the same image, then at step S75 the processing performs a pixel map correlation on the data of the previously-scanned image (or images) and the data of the just-scanned image, which is further described with reference to FIGS. 9A and 9B. It is noted that the pixel map correlation step S75 is slower than steps S71 and S72 but is more accurate at making a same page determination than either of steps S71 and S72.

After step S75, the processing proceeds to step S74, where the results of the same page determination is provided to the system 100. If step S75 determines that the previously-scanned image and the just-scanned image are the same image, then the processing proceeds to step S38 (described with respect to FIG. 3). If step S75 determines that the previously-scanned image and the just-scanned image are not the same image, then the processing proceeds to step S39, where the just-scanned image is stored in memory 182 (described with respect to FIG. 3).

FIGS. 8A and 8B further describe the run length processing step of step S72. At step S81 a run length smearing process is performed on the data of the previously-scanned image (or images) and the data of the just-scanned image wherein word “blobs” are created representing each word. For example, and as shown in FIG. 8B, the more characters that are present in the word, the longer the word “blob.” It is noted that the run length smearing step may be performed on data representing the entire page or on data representing less than the entire page.

After the run length smearing step, the data of the previously-scanned image and the data if the just-scanned image are described as a feature vector (in either the “up-down” or “right-left” directions) including the blob length in pixels. In a non-limiting embodiment, the feature vector is preferably a fast sorting/pruning hypothesis feature vector. As an example shown in FIG. 8B, the three-word phrase “I am awesome” is processed as three differently-sized word “blobs,” and is described in a table representing the number of characters in each word, namely 1(I) 2(am) and 7(awesome). At step S83, the feature vectors of the just-scanned image and the previously-scanned image are compared.

Also as shown in FIG. 8B, assuming the “I am awesome” 1, 2, 7 . . . table reflects the contents of the just-scanned image and the 2, 3, 8 . . . table represents the previously-scanned image, the comparison of these two feature vectors are then compared against a threshold feature vector value at step S84. It is again noted that the value of the just-scanned feature vector may be compared with values from one or more previously-scanned feature vectors. If at step S84 the value of the difference between the two (or more) feature vectors is less than the threshold feature vector value, then the processing will output a “same page” value at step S85, whereafter the processing next proceeds to step S73 (described with reference to FIG. 7). If at step S84 the value of the difference between the two (or more) feature vectors exceeds the threshold feature vector value, then the processing will output a “different page” value at step S85, whereafter the processing next proceeds to step S73.

FIGS. 9A, 9B and 9C further describe the pixel map correlation step of step S75. At step S91 a feature detection process is performed, wherein unique or otherwise “interesting” points of characters or groups of characters (e.g., words) with high variations are detected. For example, free ends of characters of a scanned image may be identified as points, as shown in FIGS. 9B and 9C. In FIGS. 9B and 9C, the numerical value following each word corresponds to the number of “free ends” of the characters of that word, e.g., the word “QUICK” has eleven free ends. Other examples, of unique points that can be detected include, but are not limited to corners, rounded features, flat features and the like. As used herein a “feature” is a piece of information other than pixels that is obtained by further processing the pixel information, either by integrating information from neighbor pixels or from previously-computed low-level features (e.g., edges). Thus, it is noted that those skilled in the art would appreciate that other suitable feature detection processes may be performed.

At step S92, the location on the page (e.g., the location within the captured frame of the scanned image) detected features of the unique points are then described as a one-dimensional pixel map vector.

At step S93, the described features of a previously-scanned image (or images)(Page X in FIGS. 9B and 9C) and the described features of just-scanned image (Page Y in FIGS. 9B and 9C) are matched and virtual lines L are created between the matched described features of each page (or page spread), as shown by the lines L between pages X and Y of FIGS. 9B and 9C. For example, a virtual line L is used to define a trajectory between the feature value 6 of Page X and feature value 6 of Page Y in FIG. 9B, and similarly, in FIG. 9C another virtual line L is used to define a trajectory between the feature value 6 of Page X and feature value 6 of Page Y in FIG. 9B. This process is repeated multiple times to create multiple trajectories between matched described features. In a non-limiting aspect of the disclosure, 50 described features are matched, but those skilled in the art would appreciate that greater than or fewer than 50 described features may be matched.

At step S94, the angles of the trajectories are compared with each other for consistency to obtain a trajectory angle value, defined as the angle variance between lines L: Δα. As can be seen from the in FIG. 9B, the lines L from page X to page Y are generally parallel, indicating that the trajectories are consistent (and that Page X and Page Y are the same page), and as can be seen in FIG. 9C, the lines L from page X to page Y are not parallel, indicating that the trajectories are inconsistent (and that Page X and Page Y are not the same page). At step S95, the obtained trajectory angle value Δα is compared with a threshold trajectory value T, and if the trajectory angle value is less than the threshold trajectory value, then the processing will output a “same page” value at step S96, whereafter the processing next proceeds to step S74 (described with reference to FIG. 7). If at step S95 the trajectory angle value is greater than the threshold trajectory value, then the processing will output a “different page” value at step S96, whereafter the processing next proceeds to step S74. It is noted that the pixel map correlation step operates under the assumption that if two pages (or page spreads) are the same the trajectories between matched described features should be mostly parallel. If a just-scanned image is the same as a previously-scanned image but has been slightly rotated or shifted, there still should not be crossing connects of lines L.

FIG. 10 is a more detailed flowchart explaining the image storage process of step S39. At step S101 planarization (flattening of the curves) is performed on an image of a distorted paper surface in order to obtain a uniform planarized image of the two-page surface spread. It is noted that during the book scanning process, the user may not always align the book pages with the field of view (or image frame) of the camera 23, thereby making the scanned book page appear to be askew (i.e., turned about an optical axis of the camera 23) on the video display 150. To address this phenomenon, at step S102 the scanned image to be stored is aligned with the image frame of the camera 23 so that all pages of the book appear to uniform, much like a physical book B. At step S103 additional image analysis is performed on the scanned image (including but not limited to color adjustment, glare adjustment, and the like). At step S104 the book images are stitched together so that the scanned pages appear to belong to a contiguous bound book and so that the user can easily move among the pages of the scanned book. At step S105 the scanned image is stored in memory 182.

It is noted that steps S101-S104 can be performed either during the continuous scanning mode or after the storage step S105 as an image post-processing step. In this regard, it is noted that steps S101-S105 (S39) can be performed in any sequence, for example, storage step S105 can occur before or after steps S101-S104.

It is also noted that one or more audible and/or visual cues may be provided to the user for each of the above-described steps, in accordance with a non-limiting feature.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present specification describes components and functions that may be implemented in particular embodiments with reference to particular standards and protocols, the disclosure is not limited to such standards and protocols. For example, standards for Internet and other packed switched network transmission (e.g., WiFi, Bluetooth, femtocell, microcell and the like) represent examples of the state of the art. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is not intended be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method of continuously scanning turned pages of printed material, the method comprising:
capturing, using an imaging device, a first image of a first page of the printed material in a field of view of the imaging device;
detecting by a computer processor, a page turn of the page of the printed material, said detecting comprising:
setting a motion threshold value of the captured first image, the motion threshold value having a threshold distance value and threshold a direction value;
scanning and obtaining motion values for successive image frames of the printed material, each obtained motion value having a distance value and a direction value;
comparing the motion value of each successive image frame with the motion value of a preceding image frame, such that if the motion value of a successive image frame exceeds the motion threshold value, a page turn is determined.
capturing, using the imaging device, a next, second image of a next page of the printed material in the field of view of the imaging device;
determining whether the first image and the second image is of the same page, said determining comprising:
performing a first threshold test in which first features of the first image and second image are compared; and
performing a second threshold test in which second features, different from the first features, of the first and second image are compared, wherein the second threshold test is performed faster and is less accurate than the first threshold test; and
storing the second image in a computer memory if the both first threshold test and second threshold test determine that the second image is not of the same page as the first image.

2. The method according to claim 1, wherein said determining whether the first image and the second image is of the same page further comprises performing a third threshold test in which third features, different from the first features, of the first image and second image are compared, wherein the third threshold test is performed more slowly and is more accurate than the first and second threshold tests.

3. The method according to claim 2, wherein said performing the third threshold test is performed only when said performing the first threshold test and said performing the second threshold test both determine that the first image and the second image is not of the same page.

4. The method according to claim 2, wherein said performing the third threshold test comprises:
detecting a first plurality of unique features of the first image;
detecting a second plurality of unique features of the second image;
matching at least one first unique feature of the first plurality of unique features with at least one second unique feature of the second plurality of unique features;
creating a trajectory between the at least one first unique feature and the at least one second unique feature;
comparing the created trajectory with a predetermined threshold trajectory; and
outputting a determination as to whether or not the first image and the second image are of the same image depending on the result of said comparing.

5. The method according to claim 1, further comprising deleting the lower quality of the first image and the second image when said determining determines that the first image and the second image is of the same page.

6. The method according to claim 1, wherein said performing the second threshold test comprises:
performing run length smearing of the contents of the first image;
performing run length smearing of the contents of the second image;
determining a vector of the run length smeared contents of the first image;
determining a vector of the run length smeared contents of the second image;
comparing the determined vector of the first image with the determined vector of the second image; and
outputting a determination as to whether or not the first image and the second image are of the same image depending on the result of said comparing.

7. The method according to claim 1, wherein the contents of the first image and the contents of the second image are text data.

8. The method according to claim 1, further comprising detecting a hand gesture, said detecting a hand gesture comprising:
storing a skin value;
detecting a moving object in the field of view of the imaging device;
obtaining an exterior characteristic value of the detected object;
comparing the obtained exterior characteristic value of the moving object with the stored skin value;
determining whether the moving object is a hand depending on the result of said comparing the obtained exterior characteristic value; and
tracking the motion of the moving object in the field of view when said determining whether the moving object is a hand determines that the moving object is a hand.

9. The method according to claim 8, further comprising selecting a portion of the second image, said selecting comprising:
determining at least a first position and a second position of the hand in the field of view, the first position and second positions specifying an area of the next page to be stored; and
storing only the area of the next page to be stored.

10. The method according to claim 8, further comprising:
obtaining a background page color value of the next page;
determining when the moving object stops moving;
replacing moving object image data with a background page color corresponding to the background page color value; and
storing the second image of the next page.

11. The method according to claim 1, further comprising:
determining the page numbers of the first page and next page of the printed material;
comparing the page numbers of the first page and next page; and
providing a cue to a user when the first page and next page are out of sequence.

12. A method of continuously scanning turned pages of printed material, the method comprising:
capturing, using an imaging device, a first image of a first page of the printed material in a field of view of the imaging device;
capturing, using the imaging device, a next, second image of a next page of the printed material in the field of view of the imaging device;
determining whether the first image and the second image is of the same page, said determining comprising:
performing a first threshold test in which first features of the first image and second image are compared; and
performing a second threshold test in which second features, different from the first features, of the first and second image are compared, wherein the second threshold test is performed faster and is less accurate than the first threshold test; and
storing the second image in a computer memory if the both first threshold test and second threshold test determine that the second image is not of the same page as the first image.

13. The method according to claim 12, wherein said determining whether the first image and the second image is of the same page further comprises performing a third threshold test in which third features, different from the first features, of the first image and second image are compared, wherein the third threshold test is performed more slowly and is more accurate than the first and second threshold tests.

14. The method according to claim 13, wherein said performing the third threshold test is performed only when said performing the first threshold test and said performing the second threshold test both determine that the first image and the second image is not of the same page.

15. The method according to claim 13, wherein said performing the third threshold test comprises:
detecting a first plurality of unique features of the first image;
detecting a second plurality of unique features of the second image;
matching at least one first unique feature of the first plurality of unique features with at least one second unique feature of the second plurality of unique features;
creating a trajectory between the at least one first unique feature and the at least one second unique feature;
comparing the created trajectory with a predetermined threshold trajectory; and
outputting a determination as to whether or not the first image and the second image are of the same image depending on the result of said comparing.

16. The method according to claim 12, further comprising deleting the lower quality of the first image and the second image when said determining determines that the first image and the second image is of the same page.

17. The method according to claim 12, wherein said performing the second threshold test comprises:
performing run length smearing of the contents of the first image;
performing run length smearing of the contents of the second image;
determining a vector of the run length smeared contents of the first image;
determining a vector of the run length smeared contents of the second image;
comparing the determined vector of the first image with the determined vector of the second image; and
outputting a determination as to whether or not the first image and the second image are of the same image depending on the result of said comparing.

18. The method according to claim 12, further comprising:
determining the page numbers of the first page and next page of the printed material;
comparing the page numbers of the first page and next page; and
providing a cue to a user when the first page and next page are out of sequence.

19. The method according to claim 12, wherein the contents of the first image and the contents of the second image are text data.

20. The method according to claim 12, further comprising at least one of an audible or visual cue to a user when said determining determines that the first image and the second image is of the same page.

21. A method of continuously scanning turned pages of printed material, the method comprising:
capturing, using an imaging device, an image of a page of the printed material in a field of view of the imaging device; and
detecting by a computer processor, a page turn of the page of the printed material, said detecting comprising:
setting a motion threshold value of the captured first image, the motion threshold value having a threshold distance value and a threshold direction value;
scanning and obtaining motion values for successive image frames of the printed material, each obtained motion value having a distance value and a direction value; and
comparing the motion value of each successive image frame with the motion value of a preceding image frame, such that if the motion value of a successive image frame exceeds the motion threshold value, a page turn is determined.

22. The method according to claim 21, wherein the contents of the image is text data.

23. The method according to claim 21, further comprising detecting a hand gesture, said detecting a hand gesture comprising:
storing a skin value;
detecting a moving object in the field of view of the imaging device;
obtaining an exterior characteristic value of the detected object;
comparing the obtained exterior characteristic value of the moving object with the stored skin value;
determining whether the moving object is a hand depending on the result of said comparing the obtained exterior characteristic value; and
tracking the motion of the moving object in the field of view when said determining whether the moving object is a hand determines that the moving object is a hand.

24. The method according to claim 23, further comprising selecting a portion of the second image, said selecting comprising:
determining at least a first position and a second position of the hand in the field of view, the first position and second positions specifying an area of the next page to be stored; and
storing only the area of the next page to be stored.

25. The method according to claim 23, further comprising:
obtaining a background page color value of the next page;
determining when the moving object stops moving;
replacing moving object image data with a background page color corresponding to the background page color value; and
storing the second image of the next page.

26. The method according to claim 21, further comprising at least one of an audible or visual cue to a user when a page turn is detected.

27. An image processing system connected to an imaging device and a computer having a memory, the imaging device configured to capture first and second images of respective first and second pages of printed material in a field of view of the imaging device, the image processing system comprising:
a determiner configured to determine whether the first image and the second image is of the same page by executing a first threshold test in which first features of the first image and second image are compared, and executing a second threshold test in which second features, different from the first features, of the first and second image are compared, wherein the second threshold test is performed faster and is less accurate than the first threshold test; and
a storage processor configured to instruct the computer to store the second image in the computer memory if the both first threshold test and second threshold test determine that the second image is not of the same page as the first image.

28. A page turn detection system connected to an imaging device and a computer having a memory, the imaging device configured to capture an image of printed material in a field of view of the imaging device, the image processing system comprising:
a motion threshold value setter configured to set a motion threshold value of the captured first image, the motion threshold value having a threshold distance value and a threshold direction value;
a scanning processor configured to instruct at least one of the imaging device and the computer to scan and obtain motion values for successive image frames of the printed material, each obtained motion value having a distance value and a direction value; and
a comparator configured to compare the motion value of each successive image frame with the motion value of a preceding image frame, such that if the motion value of a successive image frame exceeds the motion threshold value, a page turn is detected.

29. An apparatus for continuously scanning turned pages of printed material, the apparatus comprising:
a camera configured to capture first and second images of respective first and second pages of printed material in a field of view of the imaging device;
a determiner configured to determine whether the first image and the second image is of the same page by executing a first threshold test in which first features of the first image and second image are compared, and executing a second threshold test in which second features, different from the first features, of the first and second image are compared, wherein the second threshold test is performed faster and is less accurate than the first threshold test; and
a memory configured to store the second image if the both first threshold test and second threshold test determine that the second image is not of the same page as the first image.

30. A page turn detector comprising:
a camera configured to capture an image of printed material;
a motion threshold value setter configured to set a motion threshold value of the captured first image, the motion threshold value having a threshold distance value and a threshold direction value;
a scanner configured to scan and obtain motion values for successive image frames of the printed material, each obtained motion value having a distance value and a direction value; and
a comparator configured to compare the motion value of each successive image frame with the motion value of a preceding image frame, such that if the motion value of a successive image frame exceeds the motion threshold value, a page turn is detected.

31. At least one non-transitory computer-readable medium readable by a computer for continuously scanning turned pages of printed material, the at least one non-transitory computer-readable medium comprising:
a first capturing code segment that, when executed, captures, using an imaging device, a first image of a first page spread of the printed material in a field of view of the imaging device;
a second capturing code segment that, when executed, captures, using the imaging device, a next, second image of a next page spread of the printed material in the field of view of the imaging device;
a determining code segment that, when executed:
performs a first threshold test in which first features of the first image and second image are compared; and
performs a second threshold test in which second features, different from the first features, of the first and second image are compared, wherein the second threshold test is performed faster and is less accurate than the first threshold test; and
a storing code segment that, when executed, stores the second image in a computer memory if the both first threshold test and second threshold test determine that the second image is not of the same page spread as the first image.

32. At least one non-transitory computer-readable medium readable by a computer for detecting a page turn of a page of printed material, the at least one non-transitory computer-readable medium comprising:
a capturing code segment that, when executed, captures an image of a page of the printed material
a setting code segment that, when executed, sets a motion threshold value of the captured first image, the motion threshold value having a threshold distance value and a threshold direction value;
a scanning code segment that, when executed, scans and obtains motion values for successive image frames of the printed material, each obtained motion value having a distance value and a direction value; and
a comparing code segment that, when executed, compares the motion value of each successive image frame with the motion value of a preceding image frame, such that if the motion value of a successive image frame exceeds the motion threshold value, a page turn is detected.
